(19) United States
(12) Patent Application Publication
(10) Pub. No.: US 2015/0290908 A1
(43) Pub. Date: Oct. 15, 2015

(54) LAMINATE

(71) Applicant: NITTO DENKO CORPORATION, Ibaraki-shi, Osaka (JP)

(72) Inventors: Hiromoto Haruta, Ibaraki-shi (JP); Masamichi Matsumoto, Ibaraki-shi (JP); Wataru Nagatake, Ibaraki-shi (JP)

(73) Assignee: NITTO DENKO CORPORATION, Ibaraki-shi, Osaka (JP)

(21) Appl. No.: 14/648,567

(22) PCT Filed: Nov. 29, 2013
(86) PCT No.: PCT/JP2013/082233

§ 371 Date: May 29, 2015

(30) Foreign Application Priority Data
Dec. 7, 2012 (JP) 2012-268629
Nov. 21, 2013 (JP) 2013-241253

(51) Int. Cl. B32B 7/02; B32B 27/18; B32B 27/36; B32B 27/08; B32B 7/12

(52) U.S. Cl. CPC B32B 7/02; B32B 27/08; B32B 7/12; B32B 27/36; B32B 27/18; B32B 2307/736; B32B 2307/412; B32B 2307/202

(57) ABSTRACT

A laminate, comprising: a carrier film for a transparent conductive film comprising a support and a pressure-sensitive adhesive layer provided on at least one side of the support; and a transparent conductive film comprising a transparent conductive layer and a transparent substrate, wherein the support has an in-plane thermal shrinkage S1 of 0.3 to 0.9% when heated at 140° C. for 90 minutes, and the transparent conductive film has an in-plane thermal shrinkage S2 of 0.3 to 0.6% when heated at 140° C. for 90 minutes.

### TECHNICAL FIELD

The invention relates to a laminate comprising a carrier film for a transparent conductive film and a transparent conductive film.

### BACKGROUND ART

In touch panels, liquid crystal display panels, organic EL panels, electrochromic panels, electronic paper elements and the like, demands for elements using a film substrate obtained by providing a transparent electrode on a plastic film have recently been increasing.

At present, thin films made of an oxide of indium and tin (indium-tin oxide (ITO)) are predominant transparent electrode materials. Transparent conductive films including the ITO thin films should be protected from scratches, dirt, and other damages in manufacturing processes, feeding processes, and other processes. For this purpose, surface protective films (carrier films) or the like are attached to transparent conductive films to be used.

In order to prevent the transparent conductive film from curling, for example, a surface protective film is used on the transparent conductive film to protect its surface opposite to its conductive thin film. It is proposed that such a surface protective film for the transparent conductive film should have a thermal shrinkage of 0.9% or less in both the MD (flow direction) and the TD (transverse direction) as measured under specific conditions (see, for example, Patent Document 1).

### PRIOR ART DOCUMENTS

### Patent Documents

Patent Document 1: Japanese Patent No. 4342775

### SUMMARY OF THE INVENTION

### Problems to be Solved by the Invention

In recent years, in the field of touch panels and so on mentioned above, there has been an increasing demand for thickness reduction, and thus transparent conductive films themselves have been required to be thinner. Common types of touch panels include resistive touch panels, capacitance touch panels, etc. In the case of resistive touch panels, it is difficult at present to reduce the thickness of their transparent conductive films because their basic conductive structure is required to have pen input durability. On the other hand, in the case of capacitance touch panels, which have become widely used in recent years, their transparent conductive films can be reduced in thickness because they use changes in capacitance to detect positions. The market also has a strong demand for such a reduction in thickness.

As compared with thick transparent conductive films, thin transparent conductive films have low firmness or high brittleness and thus can be difficult to process and handle in touch panel manufacturing processes. It is therefore conceivable that a method for compensating for the decrease in the processability and handleability of a transparent conductive film may include increasing the thickness of a substrate for a surface protective film with decreasing thickness of the transparent conductive film and making the total thickness of a laminate of the transparent conductive film and the surface protective film substantially equal to the total thickness of a laminate of a conventional thick transparent conductive film and a thin surface protective film. In other words, it is conceivable that a laminate of a thin transparent conductive film and a surface protective film with a thick substrate may be subjected to various processes such as ITO thin film crystallization, cutting of the transparent conductive film, resist printing, and etching, so that it can be easily processed and handled.

However, transparent conductive films become vulnerable to thermal shrinkage as they decrease in thickness. Therefore, a new problem occurs in that even when placed on a surface protective film, a transparent conductive film can be deformed to have irregularities by the influence of immersion in a resist solution or a developer in an etching process of the touch panel manufacturing process, the influence of heating in a drying process of the touch panel manufacturing process, and other influences. If a transparent conductive film with such irregularities is used for an actual product, a pattern visibility problem can occur in which the ITO pattern tends to be visible when the display is turned on or off.

In addition, when the thickness of the transparent conductive film significantly differs from that of the surface protective film, another problem occurs in that during the process of crystallizing the ITO thin film by heating, the thermal shrinkage difference between the films causes curling of the transparent conductive film placed on the surface protective film. If the transparent conductive film curls, the laminate having the transparent conductive film can fail to be air-floated or sucked or fail to pass through a gate between processes in the process of feeing the laminate or can suffer from other failures, so that stable and continuous production can be difficult.

Patent Document 1 mentioned above addresses the curl resistance of transparent conductive films. However, Patent Document 1 neither takes into account the above problems associated with the reduction in the thickness of transparent conductive films nor the thermal shrinkage of transparent conductive films as adherends, and thus the disclosure in Patent Document 1 is not enough to solve the present problems.

It is an object of the invention to solve the conventional problems and to provide a laminate having high curl resistance that can prevent the attached transparent conductive film from significantly curling even in a heating process, for example, at about 140 to 150° C. It is another object of the invention to provide a laminate in which a transparent conductive film having good pattern visibility in addition to the curl resistance can be formed.

### Means for Solving the Problems

As a result of diligent studies to achieve the objects, the inventors have accomplished the invention based on findings that the objects can be achieved when a carrier film having a specific in-plane thermal shrinkage is used on a transparent conductive film having a specific in-plane thermal shrinkage.

The invention relates to a laminate, comprising:

a carrier film for a transparent conductive film comprising a support and a pressure-sensitive adhesive layer provided on at least one side of the support; and

a transparent conductive film comprising a transparent conductive layer and a transparent substrate, wherein

the support has an in-plane thermal shrinkage S1 of 0.3 to 0.9% when heated at 140° C. for 90 minutes, and

the transparent conductive film has an in-plane thermal shrinkage S2 of 0.3 to 0.6% when heated at 140° C. for 90 minutes.

In the laminate of the invention, the support preferably has a thickness of more than 70 μm to 200 μm or less.

In the laminate of the invention, the support preferably has a thermal shrinkage S1_{md} of 0.9% or less in a longitudinal direction of the support when heated at 140° C. for 90 minutes, and a thermal shrinkage S1_{td} of 0.6% or less in a transverse direction of the support when heated at 140° C. for 90 minutes.

In the laminate of the invention, the support is preferably a polyester resin film.

In the laminate of the invention, the pressure-sensitive adhesive layer is preferably made from a pressure-sensitive adhesive composition comprising a base polymer and a crosslinking agent.

### Effect of the Invention

In the laminate of the invention, a carrier film for a transparent conductive film including a support having a specific in-plane thermal shrinkage is bonded to a transparent conductive film having a specific in-plane thermal shrinkage, so that after heating, the transparent conductive film can be prevented from having considerable curl-induced irregularities and can be smoothly fed. When the transparent conductive film is processed in the laminate of the invention, the resulting transparent conductive film can provide good pattern visibility.

### BRIEF DESCRIPTION OF THE DRAWINGS

FIG. 1 is a schematic diagram showing a cross-section of a carrier film for a transparent conductive film in the invention; and

FIG. 2 is a schematic diagram showing a cross-section of a laminate according to the invention.

### MODE FOR CARRYING OUT THE INVENTION

The laminate of the invention includes a carrier film for a transparent conductive film including a support and a pressure-sensitive adhesive layer provided on at least one side of the support; and a transparent conductive film including a transparent conductive layer and a transparent substrate, wherein

the support has an in-plane thermal shrinkage S1 of 0.3 to 0.9% when heated at 140° C. for 90 minutes, and

the transparent conductive film has an in-plane thermal shrinkage S2 of 0.3 to 0.6% when heated at 140° C. for 90 minutes.

1. Carrier Film for Transparent Conductive Film

The invention uses a carrier film for a transparent conductive film (hereinafter also referred to simply as a “carrier film”). The carrier film includes a support and a pressure-sensitive adhesive layer provided on at least one side of the support. The support has an in-plane thermal shrinkage S1 of 0.3 to 0.9% when heated at 140° C. for 90 minutes.

The carrier film for the transparent conductive film is used on a transparent conductive film including a transparent substrate and a transparent conductive layer, and specifically used on a transparent conductive film including a transparent conductive layer and a transparent substrate and having an in-plane thermal shrinkage S2 of 0.3 to 0.6% when heated at 140° C. for 90 minutes. When the carrier film for the transparent conductive film is used on the transparent conductive film, the pressure-sensitive adhesive layer of the carrier film is bonded to the surface of the transparent substrate of the transparent conductive film opposite to its transparent conductive layer (or bonded to the surface of a functional layer if the functional layer is further provided on the surface of the transparent substrate).

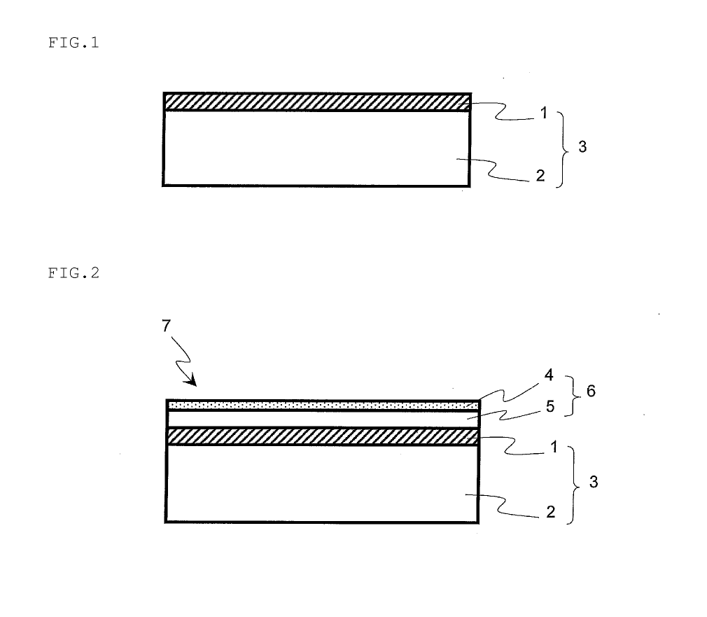

Hereinafter, an embodiment of the invention will be described in detail with reference to FIGS. 1 and 2. It will be understood that the embodiment shown in FIGS. 1 and 2 is not intended to limit the invention.

The invention uses a carrier film 3 for a transparent conductive film. The carrier film 3 includes a support 2 and a pressure-sensitive adhesive layer 1 provided at least one side of the support 2, in which the support 2 has an in-plane thermal shrinkage S1 of 0.3 to 0.9% when heated at 140° C. for 90 minutes. As shown in FIG. 2, the carrier film 3 used in the invention is placed on a transparent conductive film 6 including a transparent conductive layer 4 and a transparent substrate 5 and having an in-plane thermal shrinkage S2 of 0.3 to 0.6% when heated at 140° C. for 90 minutes. The pressure-sensitive adhesive surface of the pressure-sensitive adhesive layer 1 of the carrier film for the transparent conductive film is bonded to the surface of the transparent substrate 5 opposite to its surface in contact with the transparent conductive layer 4.

(1) Support

In the invention, the support 2, which is used to form the carrier film for the transparent conductive film, may be of any type having an in-plane thermal shrinkage S1 of 0.3 to 0.9% when heated at 140° C. for 90 minutes. In the invention, the in-plane thermal shrinkage of the support refers to the shrinkage percentage measured when the support and the pressure-sensitive adhesive are stacked in the carrier film. This is because the effect of the pressure-sensitive adhesive layer on the thermal shrinkage is so small that the thermal shrinkage of the carrier film can be regarded as the thermal shrinkage of the support. The in-plane thermal shrinkage may be measured by the following method.

<In-Plane Thermal Shrinkage>

The thermal shrinkage S1_{md} in the longitudinal direction (MD direction) of the support and the thermal shrinkage S1_{td} in the transverse direction (TD direction) of the support are calculated as follows. Specifically, a 100-mm-wide, 100-mm-long piece (test piece) is cut from the carrier film which includes the pressure-sensitive adhesive layer and the support. A cross mark is made on the support side of the test piece by drawing 80-mm-long straight lines in the MD and TD directions, respectively. The length (mm) of the mark in each of the MD and TD directions is measured with an Olympus digital compact measuring microscope STM5 (manufactured by Olympus Corporation). Subsequently, the test piece is placed and heat-treated (at 140° C. for 90 minutes) with the pressure-sensitive adhesive layer facing upward. After the test piece is allowed to cool at room temperature for 1 hour, the length of the mark in each of the MD and TD directions is measured again. The measured values are substituted into the formula below to calculate the thermal shrinkages in the MD and TD directions, respectively.

Thermal shrinkage S (%)=[(the length (mm) of the mark before the heating−the length (mm) of the mark after the heating)/(the length (mm) of the mark before the heating)]×100

The in-plane thermal shrinkage S1 (%) of the support is defined as the sum of the calculated thermal shrinkages S1_{md} and S1_{td} in the respective MD and TD directions.

The in-plane thermal shrinkage S1 of the support is preferably from 0.4 to 0.7%. In the invention, when the in-plane thermal shrinkage S1 of the support is set within the specified range, curling of the transparent conductive film can be advantageously controlled within the most suitable range.

The thermal shrinkage S1_{md} in the MD direction of the support is preferably 0.9% or less, more preferably 0.8% or less, even more preferably 0.6% or less, further more preferably 0.5% or less. The lower limit of the S1_{md} of the support is preferably, but not limited to, 0% or more, more preferably 0.1% or more, even more preferably 0.2% or more. When the S1_{md} of the support is set within the above range, the shrinkage of the laminate can be suppressed during an etching process, which is advantageous in that the transparent conductive film on the laminate of the invention can have good pattern visibility.

The thermal shrinkage S1_{td} in the TD direction of the support is preferably 0.6% or less, more preferably from −0.2 to 0.4%, even more preferably from 0.05 to 0.4%, further more preferably 0.05 to 0.30%, still more preferably 0.10 to 0.30%. For curl resistance, the S1_{md} can be kept relatively low when the S1_{td} of the support is kept at a shrinkage level (in other words, when the S1_{td} is kept at a plus level). As a result, both curl resistance and good pattern visibility can be constantly achieved in contrast to cases where a carrier film with a high S1_{md} value is used.

Examples of the support that may include a paper-based support such as a paper sheet; a fiber-based support such as a cloth, a nonwoven fabric, or a net (the raw material for which is not restricted and, for example, may be appropriately selected from Manila hemp, rayon, polyester, pulp fibers, etc.); a metal support such as a metal foil or a metal sheet; a plastic support such as a plastic film or sheet; a rubber support such as a rubber sheet; a foam material such as a foam sheet; a laminate including any combination thereof (such as a laminate of a plastic support and any other support or a laminate of plastic films (or sheets)); and any other suitable thin material. A plastic support is preferred because it can have a satisfactory level of the thermal shrinkage.

Examples of materials that may be used to form the plastic film or sheet include olefin resins including a monomer unit derived from an α-olefin, such as polyethylene (PE), polypropylene (PP), ethylene-propylene copolymers, and ethylene-vinyl acetate copolymers (EVA); polyester resins such as polyethylene terephthalate (PET), polyethylene naphthalate (PEN), and polybutylene terephthalate (PBT); polyvinyl chloride (PVC); vinyl acetate resins; polyphenylene sulfide (PPS); amide resins such as polyamide (nylon) and fully aromatic polyamide (aramid); polyimide resins; and polyether ether ketone (PEEK). These materials may be used singly or in combination of two or more. Among these materials, in particular, the polyester resins have strong toughness, processability and transparency. In a more preferred mode, therefore, any of the polyester resins are used to form the support of the carrier film for the transparent conductive film so that its ability to be handled or inspected can be improved.

There is no particular limitation on the polyester resin as long as it can be formed into a sheet, film or the like, and examples thereof include polyester films such as polyethylene terephthalate (PET), polyethylene naphthalate or polybutylene terephthalate. These polyester resins may be used alone (homopolymer), or two or more kinds of them may be used in combination after polymerization (copolymer, etc.). Among these, in particular, polyethylene terephthalate is preferably used as the material of the support. Therefore, when polyethylene terephthalate is used, the obtained carrier film is excellent in strong toughness, processability and transparency and thus workability are improved, resulting in a preferred aspect.

When the support used in the invention is a resin film, the thermal shrinkage of an original resin film (a resin film before the pressure-sensitive adhesive layer is placed thereon and before a heat treatment and other processes are performed) used to form the resin film may be, but not limited to, as follows. Specifically, the original resin film is preferably a polyester resin film with an S_{md} of 1.2% or less and an S_{td} of −0.15 to 0.6%, more preferably a polyester resin film with an S_{md} of 0.9% or less and an S_{td} of 0 to 0.6, even more preferably a polyester resin film with an S_{md} of 0.8% or less and an S_{td} of 0.1 to 0.5. A polyethylene terephthalate film with the above level of S_{md} and S_{td} is more preferred.

The support preferably has a thickness of more than 70 μm to 200 μm or less, more preferably 90 to 150 μm, even more preferably 100 to 130 μm. The support with a thickness in these ranges can form a laminate with a constant thickness when used on the transparent conductive film, which is in a thickness reduction trend. Therefore, the support with such a thickness is useful because its ability to be fed is high in a manufacturing process, a feeding process, and other processes and the use of it can prevent the problem of curl during heating in processes such as crystallization and etching.

The support may be optionally subjected to a mold release treatment, an antifouling treatment and an acid treatment using a silicone-based, fluorine-based, long chain alkyl-based or fatty acid amide-based mold releasing agent, silica powder or the like; an easy adhesion treatment such as an alkali treatment, a primer treatment, a corona treatment, a plasma treatment or an ultraviolet treatment, and an electrostatic treatment such as a coating, kneading or vapor deposition treatment.

In order to improve adhesion between the pressure-sensitive adhesive layer and the support, a surface of the support may be subjected to a corona treatment or the like. The support may be subjected to a rear surface treatment.

(2) Pressure-Sensitive Adhesive Layer

In the invention, the pressure-sensitive adhesive layer is preferably made from a pressure-sensitive adhesive composition containing a base polymer and a crosslinking agent. The pressure-sensitive adhesive composition may include an acrylic pressure-sensitive adhesive, a synthetic rubber-based pressure-sensitive adhesive, a rubber-based pressure-sensitive adhesive, a silicone-based pressure-sensitive adhesive, or other pressure-sensitive adhesives. In view of transparency, heat resistance, and other properties, an acrylic pressure-sensitive adhesive containing a (meth)acrylic polymer as a base polymer is preferred.

The (meth)acrylic polymer as a base polymer for the acrylic pressure-sensitive adhesive is preferably obtained by polymerization of a monomer component containing a (meth)acrylic ester having an alkyl group of 2 to 14 carbon atoms. The use of the (meth)acrylic ester is advantageous in view of easiness of handling and other properties.

Examples of the (meth)acrylic ester having an alkyl group of 2 to 14 carbon atoms include ethyl (meth)acrylate, n-butyl (meth)acrylate (BA), tert-butyl (meth)acrylate, isobutyl(meth)acrylate, hexyl(meth)acrylate, 2-ethylhexyl(meth)acrylate (2EHA), n-octyl(meth)acrylate, isooctyl(meth)acrylate, n-nonyl(meth)acrylate, isononyl(meth)acrylate, n-decyl(meth)acrylate, isodecyl(meth)acrylate, n-dodecyl(meth)acrylate, n-tridecyl(meth)acrylate, n-tetradecyl(meth)acrylate, etc. These may be used singly or in combination of two or more. In particular, among these (meth)acrylic esters, the (meth)acrylic ester having an alkyl group of 4 to 14 carbon atoms are preferably used, n-butyl (meth)acrylate (BA) and 2-ethylhexyl(meth)acrylate (2EHA) are more preferably used, and n-butyl (meth)acrylate (BA) is even more preferably used as a main monomer. In this aspect, the content of the main monomer is preferably 50% by weight or more, more preferably 60% by weight or more, even more preferably 80% by weight or more, further more preferably 100% by weight, based on the total weight of the “(meth)acrylic esters having an alkyl group of 2 to 14 carbon atoms” in the monomer components.

A blending amount of the (meth)acrylic monomer having an alkyl group of 2 to 14 carbon atoms is preferably 55% by weight or more, more preferably from 60 to 100% by weight, and still more preferably from 60 to 98% by weight, in the monomer components.

The monomer component may contain other polymerizable monomer other than the (meth)acrylic ester having an alkyl group of 2 to 14 carbon atoms. A polymerizable monomer or monomers for controlling the glass transition point or peeling property of the (meth)acrylic polymer may be used as the other polymerizable monomer as long as the effect of the invention is not impaired. Such monomers may be used singly or in any combination. The content of the other polymerizable monomer in the monomer component is preferably 45% by weight or less, more preferably 0 to 40% by weight.

It is possible to appropriately use, as the other polymerizable monomers, components for improving cohesive strength and heat resistance, such as a sulfonic acid group-containing monomer, a phosphoric acid group-containing monomer, a cyano group-containing monomer, a vinyl ester monomer and an aromatic vinyl monomer; and monomer components having a functional group serving as a cross-linking base point, such as a hydroxyl group-containing monomer, a carboxyl group-containing monomer, an acid anhydride group-containing monomer, an amide group-containing monomer, an amino group-containing monomer, an epoxy group-containing monomer, N-acryloyl morpholine and a vinylether monomer. These monomers may be used alone, or two or more kinds of them may be used in combination.

Examples of the carboxyl group-containing monomer include (meth)acrylic acid, carboxyethyl(meth)acrylate, carboxypentyl(meth)acrylate, itaconic acid, maleic acid, fumaric acid, crotonic acid and the like.

Examples of the acid anhydride group-containing monomer include maleic anhydride, itaconic anhydride and the like.

Examples of the hydroxyl group-containing monomer include 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, diethylene glycol monovinyl ether and the like.

Examples of the sulfonic acid group-containing monomer include styrenesulfonic acid, allylsulfonic acid, 2-(meth)acrylamide-2-methylpropanesulfonic acid, (meth)acrylamidepropanesulfonic acid, sulfopropyl(meth)acrylate, (meth)acryloyloxynaphthalenesulfonic acid and the like.

Examples of the phosphoric acid group-containing monomer include 2-hydroxyethylacryloyl phosphate.

Examples of the cyano group-containing monomer include acrylonitrile and the like.

Examples of the vinyl ester monomer include vinyl acetate, vinyl propionate, vinyl laurate and the like.

Examples of the aromatic vinyl monomer include styrene, chlorostyrene, chloromethylstyrene, α-methylstyrene and the like.

Examples of the amide group-containing monomer include acrylamide, diethylacrylamide and the like.

Examples of the amino group-containing monomer include N,N-dimethylaminoethyl(meth)acrylate, N,N-dimethylaminopropyl(meth)acrylate and the like.

Examples of the epoxy group-containing monomer include glycidyl(meth)acrylate, allyl glycidyl ether and the like.

Examples of the vinyl ether monomer include methyl vinyl ether, ethyl vinyl ether, isobutyl vinyl ether and the like.

The (meth)acrylic polymer used in the invention can be obtained by polymerization of the monomer component. There is no particular limitation on a method for polymerizing the (meth)acrylic polymer. It is possible to polymerize the (meth)acrylic polymer by known methods such as solution polymerization, emulsion polymerization, bulk polymerization and suspension polymerization, and solution polymerization is more preferable from the viewpoints of workability and the like. The polymer to be obtained may be any of a homopolymer, a random copolymer, a block copolymer and the like.

The (meth)acrylic polymer to be used in the invention preferably has a weight average molecular weight of 300,000 to 5,000,000, more preferably 400,000 to 4,000,000, and particularly preferably 500,000 to 3,000,000. In the case where the weight average molecular weight is less than 300,000, the adhesive power upon peeling increases due to an improvement in wettability to the transparent substrate of the transparent conductive film as an adherent, and therefore the adherend may be sometimes damaged in the peeling ep (re-peeling), and further an adhesive residue tends to be generated due to small cohesive strength in the pressure-sensitive adhesive layer. On the other hand, in the case where the weight average molecular weight is more than 5,000,000, fluidity of the polymer decreases and wetting to the transparent substrate of the transparent conductive film as the adherend becomes insufficient, and thus blister may tend to be generated between the adherend and the pressure-sensitive adhesive layer of the carrier film. The weight average molecular weight refers to a weight average molecular weight obtained by measuring through gel permeation chromatography (GPC).

Since it is easy to keep a balance of adherability, the above (meth)acrylic polymer preferably has a glass transition temperature (Tg) of 0° C. or lower (usually −100° C. or higher, preferably −60° C. or higher), more preferably −10° C. or lower, still more preferably −20° C. or lower, and particularly preferably −30° C. or lower. In the case where the glass transition temperature is higher than 0° C., the polymer is less likely to flow and wetting to the transparent substrate of the transparent conductive film as the adherend becomes insufficient, and thus blister may tend to be generated between the adherend and the pressure-sensitive adhesive layer of the carrier film. The glass transition temperature (Tg) of the (meth)acrylic polymer can be adjusted within the above range by appropriately changing the monomer component to be used and the composition ratio.

The pressure-sensitive adhesive layer to be used in the invention becomes excellent in heat resistance by appropriately adjusting a component unit of the (meth)acrylic polymer, a constituent ratio, selection of a cross-linking agent described below, a blend ratio and the like, and appropriately cross-linking the (meth)acrylic polymer.

It is possible to use, as the cross-linking agent in the invention, an isocyanate compound, an epoxy compound, a melamine-based resin, an aziridine compound, a metal chelate compound and the like. Among these cross-linking agents, an isocyanate compound and an epoxy compound are used particularly preferably from the viewpoint of obtaining moderate cohesive strength. These compounds may be used alone, or two or more kinds of them may be used in combination.

Examples of the isocyanate compound include lower aliphatic polyisocyanates such as butylene diisocyanate and hexamethylene diisocyanate; alicyclic isocyanates such as cyclopentylene diisocyanate, cyclohexylene diisocyanate and isophorone diisocyanate; aromatic isocyanates such as 2,4-tolylene diisocyanate, 4,4′-diphenylmethane diisocyanate and xylylene diisocyanate; and isocyanate adducts such as a trimethylolpropane/tolylene diisocyanate trimer adduct (trade name: CORONATE L, manufactured by Nippon Polyurethane Industry Co., Ltd.), a trimethylolpropane/hexamethylene diisocyanate trimer adduct (trade name: CORONATE HL, manufactured by Nippon Polyurethane Industry Co., Ltd.) and an isocyanurate compound of hexamethylene diisocyanate (trade name: CORONATE HX, manufactured by Nippon Polyurethane Industry Co., Ltd.). These compounds may be used alone, or two or more kinds of them may be used in combination.

Examples of the epoxy compound include N,N,N′,N′-tetraglycidyl-m-xylenediamine (trade name: TETRAD-X, manufactured by MITSUBISHI GAS CHEMICAL COMPANY, INC.), 1,3-bis(N,N-diglycidylaminomethyl)cyclohexane (trade name: TETRAD-C, manufactured by MITSUBISHI GAS CHEMICAL COMPANY, INC.) and the like. These compounds may be used alone, or two or more kinds of them may be used in combination.

Examples of the melamine-based resin include hexamethylolmelamine and the like. Examples of the aziridine derivative include a commercially available product under the trade name of HDU (manufactured by Sogo Pharmaceutical Co., Ltd.), a commercially available product under the trade name of TAZM (manufactured by Sogo Pharmaceutical Co., Ltd.), a commercially available product under the trade name of TAZO (manufactured by Sogo Pharmaceutical Co., Ltd.) and the like. These compounds may be used alone, or two or more kinds of them may be used in combination.

Examples of the metal chelate compound include aluminum, iron, tin, titanium, nickel and the like as metal components; and acetylene, methyl acetoacetate, ethyl lactate and the like as chelate components. These compounds may be used alone, or two or more kinds of them may be used in combination.

In the invention, the crosslinking agent is preferably used in an amount of 1 part by weight or more, more preferably 2 parts by weight or more, even more preferably more than 10 parts by weight, based on 100 parts by weight (solid basis) of the (meth)acrylic polymer. The upper limit of the amount is preferably 30 parts by weight or less, more preferably 25 parts by weight or less. The use of the crosslinking agent in an amount of less than 1 part by weight may result in insufficient crosslink, so that the resulting pressure-sensitive adhesive layer may have low cohesive strength and insufficient heat resistance and tend to cause adhesive residue. On the other hand, if the amount exceeds 30 parts by weight, the resulting pressure-sensitive adhesive layer may have higher cohesive strength, lower fluidity, and insufficient wettability to a transparent conductive film as an adherend, which may tend to cause a blister between the pressure-sensitive adhesive layer and the adherend and therefore is not preferred. These crosslinking agents may also be used singly or in combination of two or more.

The pressure-sensitive adhesive layer of the carrier film used in the invention is preferably made from a pressure-sensitive adhesive composition containing a (meth)acrylic polymer and a crosslinking agent, in which the (meth)acrylic polymer is obtained by polymerization of a monomer component containing the (meth)acrylic ester having an alkyl group of 2 to 14 carbon atoms and the functional group-containing monomer. In this case, the functional group-containing monomer may have a functional group A, the crosslinking agent may have a functional group B capable of reacting with the functional group A, and the molar ratio (B/A) of the functional group B to the functional group A is preferably 0.70 or more, more preferably 0.75 or more, even more preferably from 0.8 to 0.95. For example, when a carboxyl group-containing monomer or monomers are used as a raw material or materials, the ratio of the “total number of moles of the functional groups B of all the crosslinking agents used, wherein the functional groups B are capable of reacting with the carboxyl group”, to the “total number of moles of the carboxyl groups A of all the carboxyl group-containing monomers used as raw materials” (the molar ratio of the functional group B capable of reacting with the carboxyl group to the carboxyl group A) is preferably 0.70 or more, more preferably 0.75 or more, even more preferably from 0.8 to 0.9. When the “molar ratio of the functional group capable of reacting with the carboxyl group to the carboxyl group” is 0.70 or more, the amount of the unreacted carboxyl group in the pressure-sensitive adhesive layer can be reduced and that an increase in peel strength (adhesive power) over time, which is caused by the interaction between the carboxyl group and the adherend, can be effectively prevented.

For example, when a crosslinking agent with a functional group equivalent of 110 (g/eq), wherein the functional group is capable of reacting with a carboxyl group, is added (or mixed) in an amount of 7 g, the number of moles of the functional group of the crosslinking agent, capable of reacting with the carboxyl group, can be typically calculated as follows.

The number of moles of the functional group of the crosslinking agent, capable of reacting with the carboxyl group=(the added amount of the crosslinking agent)/(the functional group equivalent)=7/110

For example, when an epoxy crosslinking agent with an epoxy equivalent of 110 (g/eq) is added (mixed) in an amount of 7 g, the number of moles of the epoxy group of the epoxy crosslinking agent can be typically calculated as follows.

The number of moles of the epoxy group of the epoxy crosslinking agent=(the added amount of the epoxy crosslinking agent)/(the epoxy equivalent)=7/110

In the invention, a polyfunctional monomer having two or more radiation-reactive unsaturated bonds may be added in combination with the crosslinking agent or independently as a crosslinking component. In such a case, a (meth)acrylic polymer is cross-linked by irradiation with radiation. Examples of the polyfunctional monomer having two or more radiation-reactive unsaturated bonds in a molecule include polyfunctional monomers having two or more radiation-reactive of one or two or more kinds which can be cross-linked (cured) by irradiation with radiation, such as a vinyl group, an acryloyl group, a methacryloyl group and a vinylbenzyl group. Generally, those having ten or less radiation-reactive unsaturated bonds are suitably used as the polyfunctional monomer. These compounds may be used alone, or two or more kinds of them may be used in combination.

Specific examples of the polyfunctional monomer include ethylene glycol di(meth)acrylate, diethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinyl benzene, N,N′-methylenebisacrylamide and the like.

A blending amount of the cross-linking agent to be used in the invention is preferably from 1 to 30 parts by weight, and more preferably from 2 to 25 parts by weight, based on 100 parts by weight (solid content) of the (meth)acrylic polymer.

Examples of the radiation include ultraviolet rays, laser beams, α-rays, β-rays, γ-rays, X-rays, electron beams and the like, and ultraviolet rays are suitably used from the viewpoints of controllability, satisfactory handleability and costs. More preferably, ultraviolet rays having a wavelength of 200 to 400 nm are used. It is possible to irradiate ultraviolet rays using appropriate light sources such as a high-pressure mercury lamp, a microwave-excited type lamp and a chemical lamp. In the case of using ultraviolet rays as the radiation, a photopolymerization initiator is blended with a pressure-sensitive adhesive composition.

The photopolymerization initiator may be a substance which forms a radical or cation by irradiation with ultraviolet rays having an appropriate wavelength which can cause a polymerization reaction according to the kind of a radiation-reactive component.

Examples of the photoradical polymerization initiator include benzoins such as benzoin, benzoin methyl ether, benzoin ethyl ether, o-methylbenzoyl benzoate-p-benzoin ethyl ether, benzoin isopropyl ether and α-methylbenzoin; acetophenones such as benzyl dimethyl ketal, trichloroacetophenone, 2,2-diethoxyacetophenone and 1-hydroxycyclohexyl phenyl ketone; propiophenones such as 2-hydroxy-2-methylpropiophenone and 2-hydroxy-4′-isopropyl-2-methylpropiophenone; benzophenones such as benzophenone, methylbenzophenone, p-chlorobenzophenone and p-dimethylaminobenzophenone; thioxanthones such as 2-chlorothioxanthone, 2-ethylthioxanthone and 2-isopropylthioxanthone; acylphosphine oxides such as bis(2,4,6-trimethylbenzoyl)-phenylphosphine oxide, 2,4,6-trimethylbenzoyldiphenylphosphine oxide and (2,4,6-trimethylbenzoyl)-(ethoxy)-phenylphosphine oxide; benzyl, dibenzosuberone, α-acyloxime ester and the like. These compounds may be used alone, or two or more kinds of them may be used in combination.

Examples of the photocation polymerization initiator include onium salts such as an aromatic diazonium salt, an aromatic iodonium salt and an aromatic sulfonium salt; organic metal complexes such as an iron-allene complex, a titanocene complex and an arylsilanol-aluminum complex; a nitrobenzyl ester, a sulfonic acid derivative, a phosphoric acid ester, a phosphoric acid ester, a phenolsulfonic acid ester, diazonaphthoquinone and N-hydroxyimide sulfonate. These compounds may be used alone, or two or more kinds of them may be used in combination. The photopolymerization initiator is usually blended in an amount of 0.1 to 10 parts by weight, and preferably 0.2 to 7 parts by weight, based on 100 parts by weight of the (meth)acrylic polymer.

It is also possible to use in combination with auxiliary photopolymerization initiators such as amines. Examples of the auxiliary photopolymerization initiator include 2-dimethylaminoethyl benzoate, dimethylaminoacetophenone, ethyl p-dimethylaminobenzoate, isoamyl p-dimethylaminobenzoate and the like. These compounds may be used alone, or two or more kinds of them may be used in combination. The auxiliary photopolymerization initiator is preferably blended in an amount of 0.05 to 10 parts by weight, and more preferably 0.1 to 7 parts by weight, based on 100 parts by weight of the (meth)acrylic polymer.

The pressure-sensitive adhesive composition to be used in the invention may contain other known additives. For example, it is possible to appropriately blend powders such as a colorant and a pigment, a surfactant, a plasticizer, a tackifier, a low-molecular weight polymer, a surface lubricant, a leveling agent, an antioxidant, a corrosion inhibitor, a photostabilizer, an ultraviolet absorber, a polymerization inhibitor, a silane coupling agent, an inorganic or organic filler, a metal powder, a granule and a foil-shaped substance according to the use applications.

The solids content of the pressure-sensitive adhesive composition is preferably, but not limited to, 20% by weight or more, more preferably 30% by weight or more.

The pressure-sensitive adhesive layer used in the invention, which can be made from the pressure-sensitive adhesive composition described above, is preferably obtained through the crosslinking reaction of the (meth)acrylic polymer with the crosslinking agent. The carrier film for a transparent conductive film used in the invention is obtained by forming such a pressure-sensitive adhesive layer on a support. In that case, (meth)acrylic polymer is generally cross-linked after applying the pressure-sensitive adhesive composition. It is also possible to transfer a pressure-sensitive adhesive layer made of the pressure-sensitive adhesive composition after cross-linking to a support and the like.

(3) Method for Manufacturing Carrier Film for Transparent Conductive Film

A non-limiting method for forming the pressure-sensitive adhesive layer 1 on the support 2 may include, for example, applying the pressure-sensitive adhesive composition to the support 2 and removing the polymerization solvent and the like by drying to form the pressure-sensitive adhesive layer 1 on the support 2. Subsequently, curing may also be performed for purposes such as controlling the migration of components from the pressure-sensitive adhesive layer 1 and controlling the crosslinking reaction. When the pressure-sensitive adhesive composition is applied to the support 2 to form the carrier film, one or more types of solvents other than the polymerization solvent may be newly added to the pressure-sensitive adhesive composition so that the composition can be uniformly applied to the support.

It is possible to use, as the method of applying a pressure-sensitive adhesive composition, a known method to be used in the production of a pressure-sensitive adhesive tape or the like. Specific examples thereof include roll coating, gravure coating, reverse coating, roll brushing, spray coating, and air knife coating methods and the like.

The drying conditions for the drying of the pressure-sensitive adhesive composition applied to the support may be appropriately determined depending on the components or concentration of the pressure-sensitive adhesive composition, the type of the solvent in the composition, or other factors. As a non-limiting example, the pressure-sensitive adhesive composition may be dried at 20 to 200° C. for about 1 second to about 24 hours.

In the case of blending the photopolymerization initiator serving as an optional component mentioned above, the pressure-sensitive adhesive composition is applied on one or both surfaces of the support (base material, base material layer), and irradiated with light, and thus a pressure-sensitive adhesive layer can be obtained. Usually, a pressure-sensitive adhesive layer can be obtained by photopolymerization through irradiation with ultraviolet rays having an illuminance of 1 to 200 mW/cm² at a wavelength of 300 to 400 nm in a dose of about 400 to 4,000 mJ/cm².

In the carrier film for the transparent conductive film used in the invention, the pressure-sensitive adhesive layer preferably has a thickness of 5 to 50 μm, more preferably 10 to 30 μm. Within the ranges, a good balance between the adhesion and the removability can be achieved, which is a preferred mode.

2. Transparent Conductive Film

The transparent conductive film used in the invention includes, for example, as shown in FIG. 2, a transparent conductive layer 4 and a transparent substrate 5 and has an in-plane thermal shrinkage S2 of 0.3 to 0.6%. The in-plane thermal shrinkage S2 may be determined by the same method as in the case of the in-plane thermal shrinkage of the support. Specifically, the in-plane thermal shrinkage S2 may be determined by the following method.

<In-Plane Thermal Shrinkage>

The thermal shrinkage S2_{md} in the longitudinal direction (MD direction) of the transparent conductive film and the thermal shrinkage S2_{td} in the transverse direction (TD direction) of the transparent conductive film are calculated as follows. Specifically, a 100-mm-wide, 100-mm-long piece (test piece) is cut from the transparent conductive film. A cross mark is made on the test piece by drawing 80-mm-long straight lines in the MD and TD directions, respectively. The length (mm) of the mark in each of the MD and TD directions is measured with an Olympus digital compact measuring microscope STM5 (manufactured by Olympus Corporation). Subsequently, the test piece is heat-treated (at 140° C. for 90 minutes). After the test piece is allowed to cool at room temperature for 1 hour, the length of the mark in each of the MD and TD directions is measured again. The measured values are substituted into the formula below to calculate the thermal shrinkages in the MD and TD directions, respectively.

Thermal shrinkage S (%)=[(the length (mm) of the mark before the heating−the length (mm) of the mark after the heating)/(the length (mm) of the mark before the heating)]×100

The in-plane thermal shrinkage S2 (%) of the transparent conductive film is defined as the sum of the calculated thermal shrinkages S2_{md} and S2_{td} in the MD and TD directions.

The in-plane thermal shrinkage S2 of the transparent conductive film is preferably from 0.3 to 0.5%.

The transparent substrate 5 may be of any type having transparency, such as a resin film or a substrate made of glass or other materials (e.g., a substrate in the form of a sheet, a film, or a plate). A resin film is particularly preferred. The thickness of the transparent substrate 5 is preferably, but not limited to, about 10 to about 200 μm, more preferably about 15 to about 150 μm.

The material for the plastic film may be, but not limited to, various transparent plastic materials. Examples of the material for the transparent plastic film include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyethersulfone resins are preferred.

The surface of the transparent substrate 5 may be previously subject to sputtering, corona discharge treatment, flame treatment, ultraviolet irradiation, electron beam irradiation, chemical treatment, etching treatment such as oxidation, or undercoating treatment such that the adhesion of the transparent conductive layer 4 formed thereon to the substrate 5 can be improved. If necessary, the substrate 5 may also be subjected to dust removing or cleaning by solvent cleaning, ultrasonic cleaning or the like, before the transparent conductive layer 4 is formed.

The constituent material of the transparent conductive layer 4 is not particularly limited, and a metal oxide of at least one metal selected from the group consisting of indium, tin, zinc, gallium, antimony, titanium, silicon, zirconium, magnesium, aluminum, gold, silver, copper, palladium and tungsten is used. The metal oxide may further contain metal atoms shown in the above-mentioned group as necessary. For example, indium oxide (ITO) containing tin oxide, tin oxide containing antimony, and the like are preferably used, ITO is more preferably used. ITO preferably contains 80 to 99% by weight of indium oxide and 1 to 20% by weight of tin oxide.

The thickness of the transparent conductive layer 4 is preferably, but not limited to, 10 nm or more, more preferably from 15 to 40 nm, even more preferably from 20 to 30 nm.

The transparent conductive layer 4 may be formed using known conventional methods, while the methods are not particularly limited. Examples of such methods include vacuum deposition, sputtering, and ion plating. Any appropriate method may be used depending on the required film thickness.

The thickness of the transparent conductive film 6 may be from 15 to 200 μm. For a reduction in thickness, the thickness of the transparent conductive film 6 is preferably from 15 to 150 μm, more preferably from 15 to 50 μm. When used in a resistive film system, the transparent conductive film 6 may have a thickness of, for example, 100 to 200 μm. When used in a capacitance system, the transparent conductive film 6 preferably has a thickness of, for example, 15 to 100 μm and more preferably has a thickness of 15 to 50 μm, even more preferably 20 to 50 μm, in particular, to meet a demand for a further reduction in thickness in recent years.

If desired, an undercoat layer, an oligomer blocking layer, or other layer may be provided between the transparent conductive layer 4 and the transparent substrate 5.

The transparent conductive film 6 may also have a functional layer. The functional layer may be provided on the surface of the transparent conductive film opposite to its side where the transparent conductive layer 4 is provided (in other words, between the transparent substrate 5 and the pressure-sensitive adhesive layer 1 in FIG. 2).

For example, an antiglare (AG) or anti-reflection (AR) layer for improving visibility may be provided as the functional layer. The material used to form the antiglare layer may be of any type such as ionizing radiation-curable resin, thermosetting resin, or thermoplastic resin. The antiglare layer preferably has a thickness of 0.1 to 30 μm. The anti-reflection layer may be made of titanium oxide, zirconium oxide, silicon oxide, magnesium fluoride, or other materials. The anti-reflection layer may be composed of two or more layers.

A hard coating (HC) layer may also be provided as the functional layer. The material used to form the hard coating layer is preferably a cured coating made from curable resin such melamine resin, urethane resin, alkyd resin, acrylic resin, or silicone resin. The hard coating layer preferably has a thickness of 0.1 to 30 μm. A thickness of 0.1 μm or more is preferred to impart hardness. The antiglare layer or the anti-reflection layer may also be provided on the hard coating layer.

3. Characteristics and Applications of the Laminate

After heated at 140° C. for 90 minutes, the laminate of the invention preferably has an amount of curl of 0 to ±10 mm, more preferably 0 to ±6 mm in view of curl resistance. An amount of curl exceeding ±10 mm is not preferred because such an amount of curl may cause a problem such as feeding failure during use. The amount of curl can be measured by the method described in the section “EXAMPLES.”

Surface irregularities can form after etching is performed on the transparent conductive film of the laminate. Such irregularities are preferably 0.1 to 0.18 μm, more preferably 0.1 to 0.15 μm. The etching-induced irregularities can be measured by the method described in the section “EXAMPLES.”

The laminate of the invention is suitable for use as a substrate (member) for forming devices such as input unit (touch panel or the like)-equipped display devices (such as liquid crystal display devices, organic EL (electroluminescence) display devices, PDPs (plasma display panels), and electronic paper) and input devices (such as touch panels) or suitable for use in the manufacture of a substrate (member) for use in these devices. In particular, the laminate of the invention is suitable for use in the manufacture of an optical substrate for touch panels. In addition, the laminate of the invention can be used regardless of the type of touch panel or the like, such as resistive type or capacitance type.

The laminate of the invention may be subjected to processes such as cutting, resist printing, etching, and silver ink printing. After the processes, the resulting transparent conductive film may be used as a substrate (optical component) for optical devices. There is no particular limitation on the substrate for an optical device, as long as it is a substrate having optical characteristics, and examples thereof include a substrate (member) constituting devices such as display devices (liquid crystal display devices, organic EL (electroluminescence) display devices, plasma display panels (PDPs), electronic paper, etc.) and input devices (touch panels, etc.) and a substrate (member) to be used in these devices.

With the trend toward reduced thickness in recent years, substrates for these optical devices have lost firmness, so that they can easily bend or deform in a manufacturing process, a feeding process, or other processes. According to the invention, the use of the carrier film described above makes it possible to maintain curling of the optical device substrate within the most suitable range and to feed the optical device substrate with stability during processes. According to the invention, the shrinkage of an optical device caused by the influence of immersion in a resist solution or a developer during an etching process or by the influence of heating during drying can be suppressed, so that the optical device can maintain good visibility when installed in a display.

### EXAMPLES

Examples and the like specifically illustrating the constitution and effect of the invention will be descried below, but the invention is not limited thereto.

### Example 1

### Preparation of Acrylic Polymer (A)

In a four-necked flask equipped with a stirring blade, a thermometer, a nitrogen gas introducing tube and a condenser, 90 parts by weight of butyl acrylate (BA), 10 parts by weight of acrylic acid (AA), 0.2 parts by weight of 2,2′-azobisisobutyronitrile as a polymerization initiator and 234 parts by weight of ethyl acetate were charged and a nitrogen gas was introduced while stirring mildly. Then, a polymerization reaction was performed for about 7 hours while maintaining a liquid temperature inside the flask at about 63° C. to prepare an acrylic polymer (A) solution (30% by weight). The acrylic polymer (A) had a weight average molecular weight of 600,000 and a glass transition temperature (Tg) of −50° C.

### <Preparation of Pressure-Sensitive Adhesive Solution>

The above acrylic polymer (A) solution (30% by weight) was diluted with ethyl acetate to give a solution (20% by weight), and then 11 parts by weight of epoxy crosslinking agent (TETRAD-C manufactured by MITSUBISHI GAS CHEMICAL COMPANY, INC.) as a cross-linking agent was added based on 100 parts by weight (solid content) of the acrylic polymer of the solution. After mixing and stirring for about 1 minute while maintaining at about 25° C., an acrylic pressure-sensitive adhesive composition was prepared.

<Preparation of Carrier Film for Transparent Conductive Film>

The acrylic pressure-sensitive adhesive composition was applied to one side of a polyethylene terephthalate (PET) substrate (125 μm in thickness, 1.13% in thermal shrinkage S_{md} in MD direction, −0.11% in thermal shrinkage S_{td} in TD direction) and then heated at 120° C. for 60 seconds to form a 20-μm-thick pressure-sensitive adhesive layer. Subsequently, the surface of the pressure-sensitive adhesive layer was attached to the silicone-treated surface of a PET release liner (25 μm in thickness), one side of which was silicone-treated. After the resulting carrier film was stored at 50° C. for 2 days, the properties of the carrier film were such that its thermal shrinkage S1_{md} in the MD direction was 0.74%, its thermal shrinkage S1_{td} in the TD direction was −0.08%, and its in-plane thermal shrinkage S1 was 0.66%. The release liner was removed before the carrier film was used.

### Example 2

A carrier film was prepared as in Example 1, except that the acrylic pressure-sensitive adhesive composition was applied to one side of the polyethylene terephthalate (PET) substrate and then heated at 150° C. for 60 seconds in the <Preparation of carrier film for transparent conductive film> of Example 1. The resulting carrier film had a thermal shrinkage S1_{md} of 0.59% in the MD direction, a thermal shrinkage S1_{td} of −0.13% in the TD direction, and an in-plane thermal shrinkage S1 of 0.46%.

### Example 3

A carrier film was prepared as in Example 1, except that the acrylic pressure-sensitive adhesive composition was applied to one side of the polyethylene terephthalate (PET) substrate (125 μm in thickness, 0.72% in thermal shrinkage S_{md} in MD direction, 0.31% in thermal shrinkage S_{td} in TD direction) in the <Preparation of carrier film for transparent conductive film> of Example 1. The resulting carrier film had a thermal shrinkage S1_{md} of 0.41% in the MD direction, a thermal shrinkage S1_{td} of 0.13% in the TD direction, and an in-plane thermal shrinkage S1 of 0.54%.

### Example 4

A carrier film was prepared as in Example 3, except that the acrylic pressure-sensitive adhesive composition was applied to one side of the polyethylene terephthalate (PET) substrate and then heated at 150° C. for 60 seconds in the <Preparation of carrier film for transparent conductive film> of Example 1. The resulting carrier film had a thermal shrinkage S1_{md} of 0.39% in the MD direction, a thermal shrinkage S1_{td} of 0.08% in the TD direction, and an in-plane thermal shrinkage S1 of 0.47%.

### Comparative Example 1

In the <Preparation of carrier film for transparent conductive film> of Example 1, the acrylic pressure-sensitive adhesive composition was applied to one side (the silicone-treated side) of the release liner and then heated at 150° C. for 60 seconds to form a 20-μm-thick pressure-sensitive adhesive layer. Subsequently, the surface of the pressure-sensitive adhesive layer was attached to a polyethylene terephthalate (PET) substrate (125 μm in thickness, 1.13% in thermal shrinkage S_{md} in MD direction, −0.11% in thermal shrinkage S_{td} in TD direction). After the resulting carrier film was stored at 50° C. for 2 days, the properties of the carrier film were such that its thermal shrinkage S1_{md} in the MD direction was 1.02%, its thermal shrinkage S1_{td} in the TD direction was −0.10%, and its in-plane thermal shrinkage S1 was 0.92%.

### Comparative Example 2

A carrier film was prepared as in Example 1, except that the acrylic pressure-sensitive adhesive composition was applied to one side of an annealed polyethylene terephthalate (PET) substrate (125 μm in thickness, 0.12% in thermal shrinkage S_{md} in MD direction, 0.03% in thermal shrinkage S_{td} in TD direction) in the <Preparation of carrier film for transparent conductive film> of Example 1. The resulting carrier film had a thermal shrinkage S1_{md} of 0.08% in the MD direction, a thermal shrinkage S1_{td} of 0.01% in the TD direction, and an in-plane thermal shrinkage S1 of 0.09%.

### <Measurement of Weight Average Molecular Weight (Mw) of Acrylic Polymer>

A weight average molecular weight of the produced polymer was measured by gel permeation chromatography (GPC).

Apparatus: HLC-8220GPC manufactured by TOSOH CORPORATION Column:
Sample column; TSKguardcolumn Super HZ-H (one column) and TSKgel Super HZM-H (two columns), manufactured by TOSOH CORPORATION
Reference column; TSKgel Super H-RC (one column), manufactured by TOSOH CORPORATION
Flow rate: 0.6 ml/minute
Injection amount: 10 μl
Column temperature: 40° C.

### Eluent: THF

Concentration of injected sample: 0.2% by weight
Detector: differential refractometer

The weight average molecular weight was calculated in terms of polystyrene.

### <Measurement of Glass Transition Temperature (Tg)>

A glass transition temperature Tg (° C.) was determined by the following equation using the following literature value as the glass transition temperature Tgn (° C.) of a homopolymer by each monomer.

1/(Tg+273)=Σ[Wn/(Tgn+273)] Equation:

wherein Tg (° C.) denotes a glass transition temperature of a copolymer, Wn (-) denotes a weight fraction of each monomer, Tgn (° C.) denotes a glass transition temperature of a homopolymer by each monomer, and n denotes a kind of each monomer.

2-ethylhexyl acrylate (2EHA): −70° C.

Butyl acrylate (BA): −55° C.

Acrylic acid: 106° C.

“Synthesis/Design and Development of New Application of Acrylic Resin” (Chubu Management Development Center was measured as the literature value.

<Thermal Shrinkage>

(1) Thermal Shrinkages in the MD and TD Directions of the Support

The thermal shrinkage S1_{md} in the longitudinal direction (MD direction) of the support and the thermal shrinkage S1_{td} in the transverse direction (TD direction) of the support were calculated as follows. Specifically, a 100-mm-wide, 100-mm-long piece (test piece) was cut from the carrier film including the support and the pressure-sensitive adhesive layer attached to the separator. A cross mark was made on the support side of the test piece by drawing 80-mm-long straight lines in the MD and TD directions, respectively. The length (mm) of the mark in each of the MD and TD directions was measured with an Olympus digital compact measuring microscope STM5 (manufactured by Olympus Corporation). Subsequently, after the separator was peeled off, the test piece was placed and heat-treated (at 140° C. for 90 minutes) with the pressure-sensitive adhesive layer facing upward. After the test piece was allowed to cool at room temperature for 1 hour, the length of the mark in each of the MD and TD directions was measured again. The measured values were substituted into the formula below to calculate the thermal shrinkages in the MD and TD directions, respectively.

Thermal shrinkage S (%)=[(the length (mm) of the mark before the heating−the length (mm) of the mark after the heating)/(the length (mm) of the mark before the heating)]×100

Thus, the thermal shrinkages S1_{md} and S1_{md} in the MD and TD directions of the support were obtained.

(2) Thermal Shrinkages in the MD and TD Directions of the Transparent Conductive Film

The thermal shrinkage S2_{md} in the longitudinal direction (MD direction) of the transparent conductive film and the thermal shrinkage S2_{td} in the transverse direction (TD direction) of the transparent conductive film were calculated as follows. Specifically, a 100-mm-wide, 100-mm-long piece (test piece) was cut from the transparent conductive film. A cross mark was made on the test piece by drawing 80-mm-long straight lines in the MD and TD directions, respectively. The length (mm) of the mark in each of the MD and TD directions was measured with an Olympus digital compact measuring microscope STM5 (manufactured by Olympus Corporation). Subsequently, the test piece was heat-treated (at 140° C. for 90 minutes). After the test piece was allowed to cool at room temperature for 1 hour, the length of the mark in each of the MD and TD directions was measured again. The measured values were substituted into the formula below to calculate the thermal shrinkages in the MD and TD directions, respectively.

Thermal shrinkage S (%)=[(the length (mm) of the mark before the heating−the length (mm) of the mark after the heating)/(the length (mm) of the mark before the heating)]×100

Thus, the thermal shrinkages S2_{md} and S2_{td} in the MD and TD directions of the transparent conductive film were obtained.

(3) In-Plane Thermal Shrinkage

The in-plane thermal shrinkages of the support and the transparent conductive film were calculated from the following formulae.

The in-plane thermal shrinkage S1 (%) of the support=S1_{md}+S1_{td}

The in-plane thermal shrinkage S2 (%) of the transparent conductive film=S2_{md}+S2_{td}

<Curl Resistance>

A transparent conductive film 1 including a 100-μm-thick PET substrate and a very thin ITO layer (30 nm in thickness) formed thereon was provided (0.48% in thermal shrinkage in MD direction, −0.13% in thermal shrinkage in TD direction). The carrier film obtained in each of the examples and the comparative examples for the transparent conductive film was bonded to the PET substrate of the transparent conductive film 1 using a hand roller (in such a manner that the pressure-sensitive adhesive layer of the carrier film was bonded to the PET substrate of the transparent conductive film). A sample piece with a size of 100 mm×100 mm was cut from the resulting laminate. The sample was heated at 140° C. for 90 minutes with the ITO surface facing upward and then allowed to cool at room temperature (23° C.) for 1 hour. Subsequently, the sample was placed on a horizontal surface with the ITO layer facing upward, and the height (mm) of each of the four corners of the laminate sample from the horizontal surface was measured. The average (mm) of the measurements was used as a measure of curling. Three samples (n3) were measured for the evaluation. The carrier film obtained in Example 1 for the transparent conductive film was further subjected to the evaluation of curl resistance in the same manner using a transparent conductive film 2 (0.41% in thermal shrinkage in MD direction, −0.32% in thermal shrinkage in TD direction) including a 100-μm-thick PET substrate and a very thin ITO layer (30 nm in thickness) formed thereon. This was named Comparative Example 3.

When the absolute value of the measured value is 0 to 6 mm, the curl resistance is particularly good. When the absolute value of the measured value is more than 6 to 10 mm, the curl resistance is good. On the other hand, when the absolute value of the measured value is more than 10 mm, a curl resistance problem may occur.

<Etching-Induced Surface Irregularities>

A transparent conductive film 1 including a 100-μm-thick PET substrate and a very thin ITO layer (30 nm in thickness) formed thereon was provided (0.48% in thermal shrinkage in MD direction, −0.13% in thermal shrinkage in TD direction). The carrier film obtained in each of the examples and the comparative examples for the carrier film was bonded to the PET substrate of the transparent conductive film 1 using a hand roller (in such a manner that the pressure-sensitive adhesive layer of the carrier film was bonded to the PET substrate of the transparent conductive film). A sample piece with a size of 120 mm×120 mm was cut from the resulting laminate. The cut sample was heat-treated at 140° C. for 90 minutes with the ITO surface facing upward and then allowed to cool for 5 minutes. Twenty commercially available polyimide tapes (2 mm in width) were attached at intervals of 2 mm to the ITO surface. Subsequently, a vessel containing hydrochloric acid was immersed in a water bath so that the temperature of hydrochloric acid was kept at 50° C. The sample was immersed in the hydrochloric acid at 50° C., allowed to stand for 5 minutes, and then washed with water. After the surface resistance was measured to check that the ITO layer was etched, the polyimide tapes were peeled off. Subsequently, the sample was dried at 140° C. for 30 minutes. The carrier film obtained in Example 1 for the transparent conductive film was further subjected to the evaluation of etching-induced irregularities in the same manner using a transparent conductive film 2 (0.41% in thermal shrinkage in MD direction, −0.32% in thermal shrinkage in TD direction) including a 100-μm-thick PET substrate and a very thin ITO layer (30 nm in thickness) formed thereon. This was named Comparative Example 3.

The surface irregularities were measured under the following conditions.

Analyzer: Optical Profiler NT9100 (manufactured by Veeco Instruments Inc.)

Measurement conditions: measurement type: VSI (infinite scan); objective: 2.5×; FOV: 1.0×; modulation threshold: 0.5%.

Using the stitching function, the irregularities of the cross-sectional profile were actually measured based on an image with a size of 5 mm×1.8 mm. Three samples (n3) were used for the evaluation.

When the measured value is 0.1 μm to 0.15 μm, the evaluation of the surface irregularities is good (indicated by “O”). When the measured value is more than 0.15 μm to 0.19 μm, the evaluation of the surface irregularities is fair (indicated by “Δ”). When the measured value is more than 0.19 μm, the evaluation of the surface irregularities is poor (indicated by

<Pattern Visibility>

The sample for the evaluation of the etching-induced surface irregularities was placed on a black acrylic plate and allowed to stand under a fluorescent light. While the sample was moved on the black acrylic plate, it was visually evaluated whether and how the reflected image of the fluorescent light looked distorted like stairs.

The case where the image of the fluorescent light looked straight was evaluated as A (good).

The case where the image of the fluorescent light looked slightly distorted like stairs was evaluated as B (fair).

The case where the image of the fluorescent light looked significantly distorted like stairs was evaluated as C (poor).

The case where the result of the evaluation was A (good) or B (fair) was determined to be no problem, whereas the case where the result of the evaluation was C (poor) was determined to be unacceptable.

TABLE 1

| | Support | | | | | | | | | | |
|---|---|---|---|---|---|---|---|---|---|---|---|
| | Thermal shrinkage | | Thermal shrinkage (%) | | | Transparent conductive film | | | | | |
| | (%) of original PET | | of support | | | Thermal shrinkage (%) | | | | | Etching- |
| | MD | TD | MD | TD | In- | MD | TD | In- | Curl | | induced surface |
| | direction | direction | direction | direction | plane | direction | direction | plane | resistance | Pattern | irregularities |
| | (S_{md}) | (S_{td}) | (S1_{md}) | (S1_{td}) | (S1) | (S2_{md}) | (S2_{td}) | (S2) | (mm) | visibility | (μm) |
| Example 1 | 1.13 | −0.11 | 0.74 | −0.08 | 0.66 | 0.48 | −0.13 | 0.35 | −8 | B | 0.19 |
| Example 2 | 1.13 | −0.11 | 0.59 | −0.13 | 0.46 | 0.48 | −0.13 | 0.35 | −6 | B | 0.17 |
| Example 3 | 0.72 | 0.31 | 0.41 | 0.13 | 0.54 | 0.48 | −0.13 | 0.35 | 3 | A | 0.16 |
| Example 4 | 0.72 | 0.31 | 0.39 | 0.08 | 0.47 | 0.48 | −0.13 | 0.35 | 0 | A | 0.15 |
| Compar- | 1.13 | −0.11 | 1.02 | −0.10 | 0.92 | 0.48 | −0.13 | 0.35 | −13 | C | 0.21 |
| ative | | | | | | | | | | | |
| Example 1 | | | | | | | | | | | |
| Compar- | 0.12 | 0.03 | 0.08 | 0.01 | 0.09 | 0.48 | −0.13 | 0.35 | 12 | A | 0.12 |
| ative | | | | | | | | | | | |
| Example 2 | | | | | | | | | | | |
| Compar- | 1.13 | −0.11 | 0.74 | −0.08 | 0.66 | 0.41 | −0.32 | 0.09 | −14 | B | 0.19 |
| ative | | | | | | | | | | | |
| Example 3 | | | | | | | | | | | |

The results in Table 1 show that in all the examples, good curl resistance was obtained, and the evaluation of pattern visibility and etching-induced surface irregularities was also good.

In the comparative examples, however, low curl resistance was obtained, and the transparent conductive film had considerable surface irregularities, which were at a level that could cause a problem with feeding. In Comparative Example 1, the pattern visibility and the etching-induced irregularities were not acceptable, and in Comparative Examples 2 and 3, the curl resistance was not acceptable.

### DESCRIPTION OF REFERENCE SIGNS

In the drawings, reference numeral 1 represents a pressure-sensitive adhesive layer, 2 a support, 3 a carrier film for a transparent conductive film, 4 a transparent conductive layer, 5 a transparent substrate, 6 a transparent conductive film, and 7 a laminate.

1. A laminate, comprising:
a carrier film for a transparent conductive film comprising a support and a pressure-sensitive adhesive layer provided on at least one side of the support; and
a transparent conductive film comprising a transparent conductive layer and a transparent substrate, wherein
the support has an in-plane thermal shrinkage S1 of 0.3 to 0.9% when heated at 140° C. for 90 minutes, and
the transparent conductive film has an in-plane thermal shrinkage S2 of 0.3 to 0.6% when heated at 140° C. for 90 minutes.

2. The laminate according to claim 1, wherein the support has a thickness of more than 70 μm to 200 μm or less.

3. The laminate according to claim 1, wherein the support has a thermal shrinkage S1_{md} of 0.9% or less in a longitudinal direction of the support when heated at 140° C. for 90 minutes.

4. The laminate according to claim 1, wherein the support has a thermal shrinkage S1_{td} of 0.6% or less in a transverse direction of the support when heated at 140° C. for 90 minutes.

5. The laminate according to claim 1, wherein the support is a polyester resin film.

6. The laminate according to claim 1, wherein the pressure-sensitive adhesive layer is made from a pressure-sensitive adhesive composition comprising a base polymer and a crosslinking agent.

7. The laminate according to claim 2, wherein the support has a thermal shrinkage S1_{md} of 0.9% or less in a longitudinal direction of the support when heated at 140° C. for 90 minutes.

8. The laminate according to claim 2, wherein the support has a thermal shrinkage S1_{td} of 0.6% or less in a transverse direction of the support when heated at 140° C. for 90 minutes.

9. The laminate according to claim 3, wherein the support has a thermal shrinkage S1_{td} of 0.6% or less in a transverse direction of the support when heated at 140° C. for 90 minutes.

10. The laminate according to claim 2, wherein the support is a polyester resin film.

11. The laminate according to claim 3, wherein the support is a polyester resin film.

12. The laminate according to claim 4, wherein the support is a polyester resin film.

13. The laminate according to claim 2, wherein the pressure-sensitive adhesive layer is made from a pressure-sensitive adhesive composition comprising a base polymer and a crosslinking agent.

14. The laminate according to claim 3, wherein the pressure-sensitive adhesive layer is made from a pressure-sensitive adhesive composition comprising a base polymer and a crosslinking agent.

15. The laminate according to claim 4, wherein the pressure-sensitive adhesive layer is made from a pressure-sensitive adhesive composition comprising a base polymer and a crosslinking agent.

16. The laminate according to claim 5, wherein the pressure-sensitive adhesive layer is made from a pressure-sensitive adhesive composition comprising a base polymer and a crosslinking agent.
